(19) United States
(12) Patent Application Publication
(10) Pub. No.: US 2002/0178087 A1
(43) Pub. Date: Nov. 28, 2002

(54) Internet-based instant messaging hybrid peer-to-peer distributed electronic commerce system and method

(76) Inventors: Greg S. Henderson, (US); John Turner, (US)

Correspondence Address: GREENBERG TRAURIG, P.A., 1221 Brickell Avenue, Miami, FL, 33131, US

(21) Appl. No.: 10/155,682

(22) Filed: May 23, 2002

Related U.S. Application Data
(60) Provisional application No. 60/293,769, filed on May 25, 2001.

(51) Int. Cl. G06F 17/60

(52) U.S. Cl. 705/26

(57) ABSTRACT

An Internet-based instant messaging hybrid peer-to-peer distributed electronic commerce system and method. The system creates a direct peer-to-peer online communications environment through proprietary software, which is Internet-based, not web based, meaning that users can communicate directly with each other using an instant messaging application rather than having to direct all communications through the system end web server, utilizing system end communications capacity. The system end applications provide a searchable database of users, goods and services and provides user and transaction verification and processing. The software consists of two applications working together in a hybrid, peer-to-peer structure creating a distributed e-commerce environment. A method for engaging in electronic commerce utilizing the above-described system is also disclosed and claimed.

### BACKGROUND OF THE INVENTION

A. Field of the Invention

The present invention relates to methods and systems for engaging in business transactions via the Internet. More particularly, the present invention relates to an Internet-based instant messaging electronic commerce system and method. The system creates a direct peer-to-peer online communications environment through proprietary software, which is Internet-based, not web based, meaning that users can communicate directly with each other using an instant messaging application rather than having to direct all communications through the system end web server, utilizing system end communications capacity. The system end applications provide a searchable database of users, goods and services and provides user and transaction verification and processing. The software consists of two applications working together in a hybrid, peer-to-peer structure creating a distributed e-commerce environment.

B. Background

The market for goods and services is becoming increasingly global, with orders for such goods or services originating from several countries. It is, therefore, desirable to provide a quick and efficient way to order products or services through a global network of computers, such as those connected to each other via the Internet. The Internet is a collection of interconnected (public and/or private) networks that are linked together by a set of standard protocols, such as TCP/IP to form a global, distributed network. While this term is intended to refer to what is now commonly known as the Internet, it is also intended to encompass variations which may be made in the future, including changes and additions to existing standard protocols.

Vendors seeking to utilize the Internet to sell their products or services have provided buyers with direct access to a database of their products or services through the Internet. This practice has been utilized with various types of businesses, for instance, in the electronic components industry. For example, large corporations, such as IBM and Motorola, have direct access to databases and the sales systems of their respective suppliers and distributors for satisfying their procurement needs. The prior art describes computerized shopping systems which employ some kind of central database of goods and services offered to buyers. Information about the goods and services offered is stored centrally. In such systems a vendor provides its database of goods and/or services to a buyer who orders items from the vendor's database. It is analogous to walking into a vendor's store and selecting items from the vendor's available stock.

In other prior art systems a number of vendors combine to offer their collective inventory to buyers through individual databases or a combined database of available goods or services. In yet another existing system a primary seller, such as an insurance agency, offers to provide to buyers premium quotations from the insurance carriers for which the agency is an agent.

With the growth of the Internet, various online systems for transacting business have been established. Typically, e-commerce systems are comprised of web based sites which use the older network architecture of a main server handling most of the load and have problems that come with such an architecture.

There are several prior art electronic sales and transaction processing methods and systems for general applications. For example, U.S. Pat. No. 5,664,115 to Fraser is directed to an interactive computer system to match buyers and sellers of real estate, businesses and other property using the Internet. This invention is essentially a bulletin board searching and screening system whereby purchasers can search for goods and sellers can screen buyers.

Similarly, U.S. Pat. No. 5,732,400 to Mandler et al. is directed to a system and method enabling online transactional services among sellers and buyers having no previous relationship with each other. The system is essentially a seller's broker system, including a financial clearinghouse for receiving requests for goods or services from a buyer and making a real-time risk classification of the buyer using an online repository of credit information. Approved buyers send requests for quotes through the financial clearinghouse to sellers with respect to particular goods and sellers then respond to the requests. The buyer then makes a purchase selection and the financial clearinghouse transmits the purchase amount to the seller and an invoice to the buyer.

Another prior art example is U.S. Pat. No. 5,842,178 to Giovannoli, which is directed to a computerized system for processing requests for quotation for goods and services between buyers and sellers by filtering buyer requests to sellers with products matching the buyers' specified criteria rather than by compiling a database of available goods or services.

Still other prior art systems include those described in U.S. Pat. No. 5,870,717 to Wiecha and U.S. Pat. No. 5,319,542 to King, Jr. et al., both of which are directed to systems for ordering goods or services over computer networks using electronic catalogs.

The main problem with conventional e-commerce sites are they are web-based and not Internet-based, which means users must access the website and a central server to use them. In an e-commerce environment, this drives prices higher, not lower. Most sites use a portal architecture, which involves many users connecting to one central server. This architecture has been shown to break down under user demands and major destination servers have had to create complex systems to try to handle the massive traffic load. The-traditional paradigm of web-based communications consists of a host server connecting a number of users through their respective individual channels. Under this paradigm, a great deal of computing resources are consumed by the host server. The traditional paradigm is no longer adequate in meeting the dynamic and flexible environment demanded by the activity of the network users of today and of the future. Given the level of activity on the Internet, a peer-to-peer paradigm is desirable. In a peer-to-peer paradigm, there is typically no host server, and a number of users are connected via a number of channels in a variety of manners.

### SUMMARY OF THE INVENTION

The present invention utilizes a hybrid peer-to-peer/server configuration. The host server is used for account creation, initial authentication and data storage. All communications on the network are peer-to-peer and do not require the server. In the event that a user is not online, the server stores the message(s) until the user returns. If the offline user has selected an alternate message delivery scheme, the messages will be passed along via that route as well as sent to their system user file (e.g., e-mail). The advantage with this paradigm is that it minimizes the central host server to connect the clients, while avoiding the biggest disadvantage for true peer-to-peer, namely having no centralized processing center means that nodes of the network (peers) must remain online 24/7 to offer their content to the network. The only way to achieve desired performance is with the introduction of a centralized storage/processing center. As long as the clients utilize application programs allowing communication across networks between the clients, this network paradigm is feasible and desirable.

A problem with conventional e-commerce sites is that they don't provide for direct communication between users, such as buyers and sellers. The system typically acts as a “middleman” between the buyer(s) or sellers(s), which increases cost and time. At best, most systems allow a buyer or seller to limited e-mail messages or short messages relayed through a third party. This system is unreliable.

Still another problem with many conventional Internet e-commerce sites are they are auction-like in nature. The purpose of an auction is get the highest price, not the lowest. Also, because it is an auction, there is a time element which means users can't buy immediately but have to wait until the end of the auction. This ignores one of fundamental advantages of the Internet, which is instant information, creating instant fulfillment and a more efficient market.

While these e-commerce websites may be suitable for the particular purpose to which they address, e.g., auctions, they are not as suitable for buyers and sellers wanting to use the Internet to instantly communicate and negotiate transactions directly through the Internet in an equal or peer-to-peer method.

The present invention creates such a peer-to-peer environment through proprietary software which is Internet, not web based. A designated location on the network (e.g., the system server) on an interconnected network such as the Internet is setup in such a manner that users can easily connect to each other by making a few simple selections. The IP addresses of the users are maintained at the designated site and are transmitted to other users to allow them to connect directly without the users having to know the IP addresses of other users. Once the connection is established, no data goes through the designated site or a central host. Data packets are directly sent to and received by the respective application program of each participant.

The system server hosts user communications by receiving and redistributing data packets and further facilitates the establishment of direct connections between users. If the user is unavailable, the server stores the message until the user is available. Data transmission from one user to another user is routed directly via the appropriate Internet protocol and transmission paths. A user using the system establishes an Internet connection with other users without the user having to know the IP address of other users. This works because a list of IP addresses is sent to the user at login. This list contains all the IP addresses for that user's buddies or favorite sellers, etc. The software consists of two applications working together in a hybrid, peer-to-peer structure creating a distributed e-commerce environment.

The present invention substantially departs from the conventional concepts and designs of the prior art, and in so doing provides a system and method for e-commerce enabling buyers and sellers using the Internet through computers or other wireless application protocol (“WAP”) compatible devices to instantly communicate and negotiate transactions directly with each other.

### BRIEF DESCRIPTION OF THE DRAWINGS

FIG. 1 is a diagram of the basic system architecture of the system of the present invention.

FIG. 2 is a flowchart describing the overall process flow of the present invention.

FIG. 3 is a sample status screen of the end user software application of the present invention in a preferred embodiment.

FIG. 4 is a sample search screen of the end user software application of the present invention in a preferred embodiment.

FIG. 5 is a sample display screen of the end user software application of the present invention in a preferred embodiment.

FIG. 6 is a sample favorites screen of the end user software application of the present invention in a preferred embodiment.

FIG. 7 is a sample chat/messaging screen of the end user software application of the present invention in a preferred embodiment.

FIG. 8 is a sample of the instant messaging screens of the present invention in a preferred embodiment.

FIG. 9 is a sample inventory control screen of the end user software application of the present invention in a preferred embodiment.

FIG. 10 is a sample order tracking screen of the end user software application of the present invention in a preferred embodiment.

FIG. 11 is a sample wish list screen of the end user software application of the present invention in a preferred embodiment.

FIG. 12 is a sample system-end software application server administration screen of the present invention in a preferred embodiment.

FIG. 13 is a diagram depicting information flow in a purchase transaction involving wireless communications means using the system in a preferred embodiment.

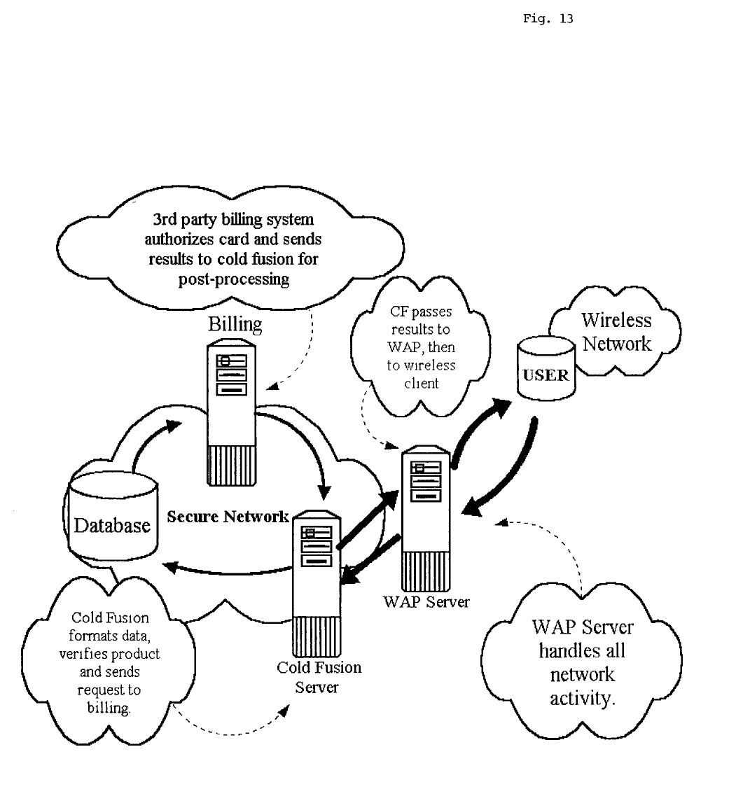

FIG. 14 is a sample user database screen of the present invention in a preferred embodiment.

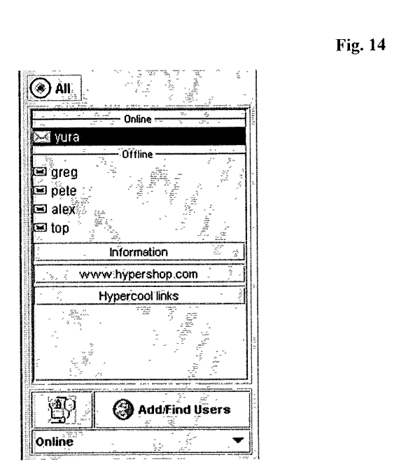

FIG. 15 depicts sample screens of a wireless communications device application of the present invention.

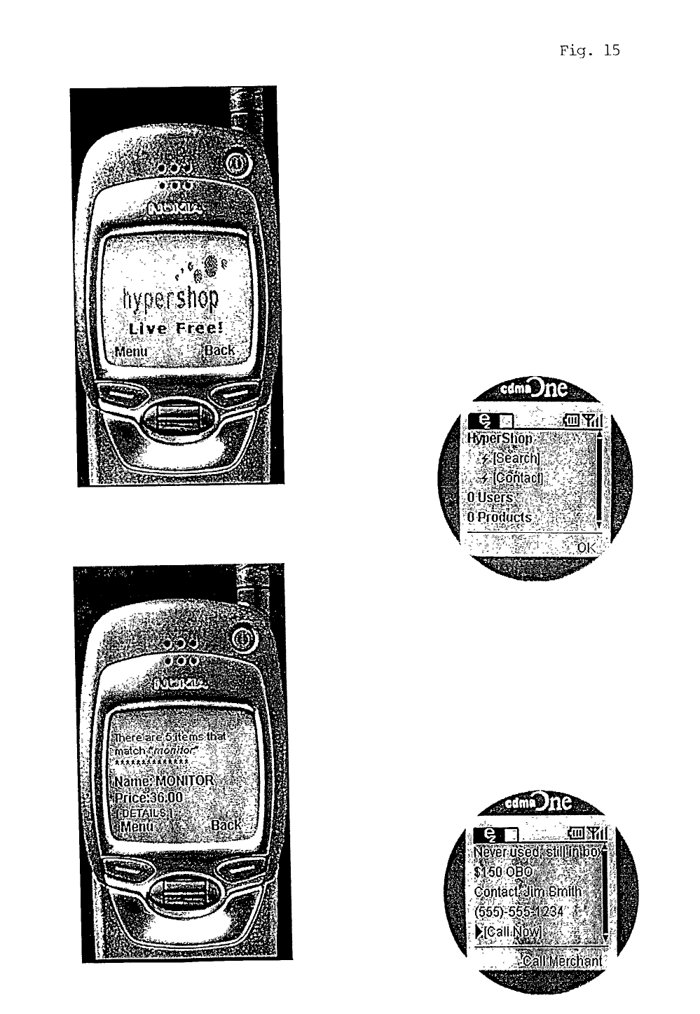

### DESCRIPTION OF A PREFERRED EMBODIMENT OF THE INVENTION

The present invention comprises one or more relational databases, instant messaging means, and two software applications working in tandem to allow e-commerce transactions. The two software applications are the user-side software application, which is used by buyer and seller alike, and the system server-end application. The system server end application is a distributed client management application using a distributed e-commerce environment. The instant messaging application is similar to ICQ, Yahoo! Messaging or MSN enabling message/file transfer. The user-side software application is used by a buyer or seller to post their goods or to search for items to purchase, as well as manage their contacts and inventory. The system-side software applications operate behind the scenes to coordinate the different uses of the client software.

System Architecture.

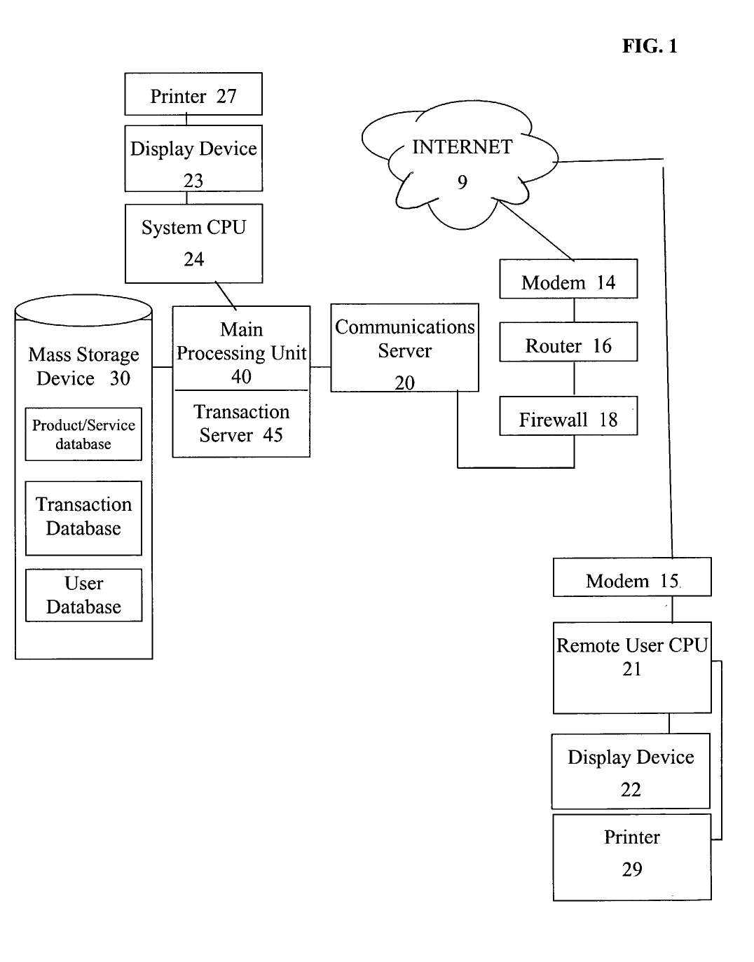

Referring now to FIG. 1, the primary elements of the computer network architecture of the system of the present invention in a preferred embodiment are depicted in the form of a block diagram.

The system of the present invention in a preferred embodiment comprises an Internet communications server 20 communicating with users and also with the other system-side components, said system-side components further comprising a mass storage device 30 having, in a preferred embodiment, searchable goods/services, user and transaction relational databases and a main processing unit 40 with a transaction server 45. The system may also include the use of routers 16 and firewalls 18 for creation of secure private communications networks between the system and users. A system CPU 24 includes a display device 23 and printer 27.

The system databases within the mass storage device 30 are searchable relational databases containing various categories of system data, such as goods/services, user and transaction information. The databases can be resident in a structured query language (“SQL”) server. The SQL can be programmed to allow searching of the databases based on user specified criteria. These components are operatively connected to commonly used input/output (“I/O”) interface devices that control various corresponding I/O devices. These I/O devices may include such conventional elements as a video display device 23, a keyboard, a printer 27, a mouse and a digitizer or scanner.

As with other computer systems, the operating system kernel of the system-end server provides software instructions to enable said server to execute necessary software applications performing the system functions, including interfacing and communicating with users, database management, searching and updating; and controlling various event-driven algorithms through which the system processes transactions appropriately based on the directions indicated by user action such as pressing keys or clicking a mouse. Other optional applications include data encryption/decryption and electronic signature generation and authentication applications, as well as electronic payment applications.

The system exchanges data with a plurality of remote CPU terminals 21 (which can have their own display devices 22, printers 25 and other peripheral equipment) via known methods utilized for Internet communications, namely, data transmission across telephone and data transmission lines, typically through routers 16 and modems 14 and 15. Data transmission on the system end utilizes a gateway that interfaces the system to remote terminals with a protocol understood by said remote terminals or intermediary equipment connected thereto. For example, in a preferred embodiment of the present system, data is transmitted to and from the system via the Internet 9 using transmission control protocol/Internet protocol (“TCP/IP”). Communications between users is direct rather than through the system-end communications server 20.

System Software Applications.

The system software is designed for rapid scalability through its peer-to-peer backend and server clustering topologies. Maximizing on an end-user client, the software delivers applications on the client-side that include a boolean keyword search, and a messaging application with functionality comparable to ICQ and AOL. The system allows for real time communications between the buyers and sellers in a number of mediums, including text chat and video/voice conferencing. This gives the buyer an opportunity to “haggle” over items listed on the system. Unlike auctions, there are no timeframes or price reserves for sales unless stated by the seller.

The system software consists of two applications working in tandem to create the largest online database of bargain products and services offered by corporate merchants as well as individual sellers. The heart of the system software is the client-side application used by merchants and prospective buyers alike. This application is completely proprietary in nature and is designed specifically for interaction with the system server. It is a distributed client management application using distributed e-commerce environment or “DEE” technology.

The system can also be accessed and used through wireless communications which means utilizing wireless application protocol (“WAP”). WAP is a standard for providing cellular phones, pagers and other handheld devises with secure access to e-mail and Web pages. The system software allows buyers or sellers to transact business on the go using their cell phones or any devices which are WAP compatible.

Both client and server software have been developed in the Java programming language to save time and money while reaching the largest user base possible. Other languages and environments, such as, without limitation, Microsoft Windows, can also be utilized. To ensure efficient communication over the Internet, both users and the system-end server communicate on a dedicated port using, in a preferred embodiment, the TCP/IP protocol. Contemplated exceptions to this would include, without limitation, users behind a firewall or proxy. To handle these users, the user-end software application supports SOCKS4 and SOCKS5 proxy protocols as well as HTTP Tunneling.

In a preferred embodiment, a hybrid high-level development language used to program for DEE, or Distributed E-commerce Environment Markup Language (“DEEML”) is utilized. DEEML uses the best of all known Internet programming languages and functions similarly to the well-tested XML language. By using this language, one application can be programmed for any device, therefore bypassing lengthy development times. Through DEEML, the invention works like a web browser interprets and displays HTML. Without having to recreate an entire application from scratch in many languages, developers can write modules for the inventions DEE platform. This would allow companies to distribute a ready-made application to the masses, that is customized for their needs. This can be done easily and cheaply as the DEEML language is easy to learn. Users with any XML experience will be able to master DEEML with only a few hours of study. DEEML does to distributed computing what Mozzila (Netscape) did for web pages.

The system-end software applications also include an open-ended application test framework, which is used to test the limits and capacity of the system network. This information is invaluable in locating and isolating security and network issues quickly and effectively.

Instant Messaging.

The system includes a proprietary software instant messaging application similar to ICQ, Yahoo! Messaging or MSN. The instant messaging application is integrated with other user-side software applications and system-side software applications managing the relational database and providing a system for buyers or sellers to post their goods or to search for items to purchase. The system-side software applications operate behind the scenes to coordinate the various system operations. The instant messaging component informs users when individuals in their list of “buddies” (buyers, sellers, people with common interests) log onto the system so that they can chat securely, directly and without centralized (third party) logging. It also notifies them if a “buyer” or “seller” sends them a message. This system also allows two or more users on the Internet to chat via public or private chatrooms or voice/video. The chat can be accomplished by typing on the keyboard, as well as audio and video-based methods. The instant messaging component can be run in various known environments, such as, without limitation, a Java, WAP, or Microsoft Windows. Different operating environments may cause the application to appear different but it still functions in the same manner. The instant messaging component can be used independently as a stand-alone application, enabling direct peer-to-peer communications without tying up system communication resources, thereby providing for quicker and more secure communications and system operation.

User-Side System Software Applications.

The system also includes user-side software applications enabling a buyer or seller to post their goods or to search for items to purchase. Users can also list requests for goods or services. This is the end-user software which resides on the user's computer. It provides a secure interface to the system with user registration and login functions includes a graphical user interface (“GUI”), which allows users to post goods or services for others to see, and then utilize the system's instant messaging application after they have downloaded, installed and registered the system software.

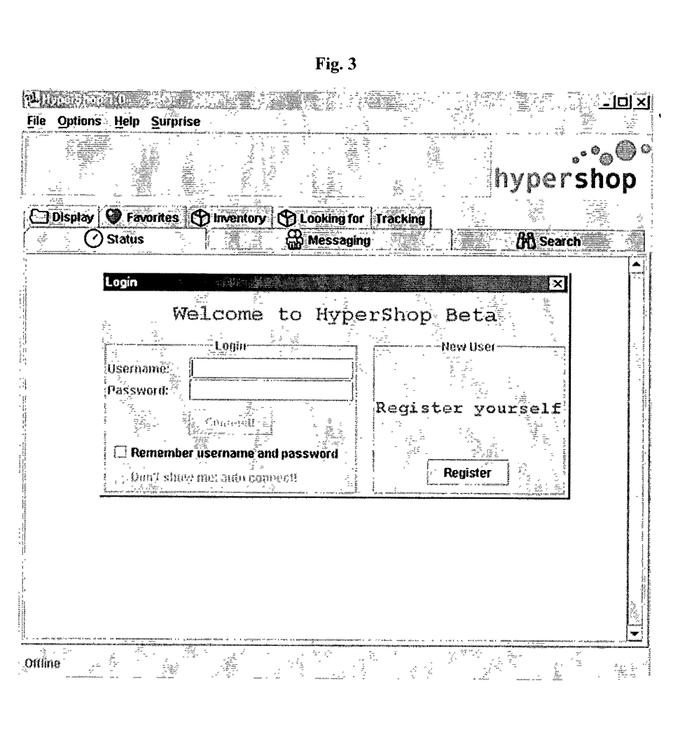

Graphically, the user-side software application provides a plurality of screens, such as, in one embodiment having seven screens, status, search, display, favorites, chat/messaging, order tracking, and inventory control screens. Referring now to FIGS. 3-10 which depict non-limiting examples of such screens:

Status Screen.

FIG. 3 depicts a sample status screen. The status screen displays online time, server messages, errors and update messages.

Search Screen.

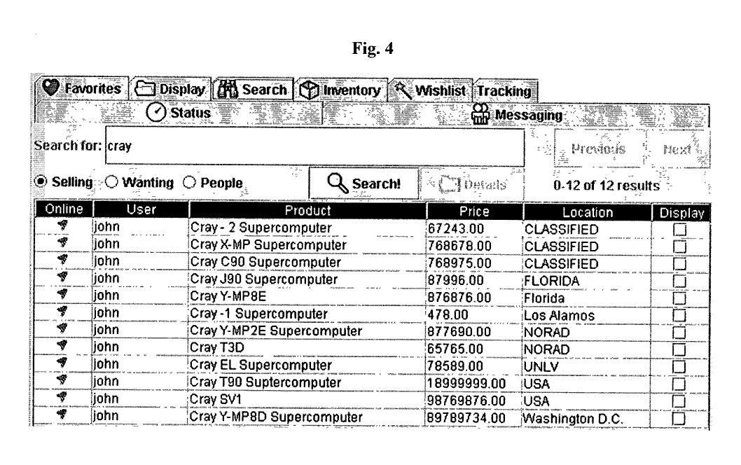

FIG. 4 depicts a sample search screen. The search screen allows manipulation of the system database using boolean or other known search methods and searches by characteristics such as, by way of non-limiting example, pricing and seller's location.

Display Screen.

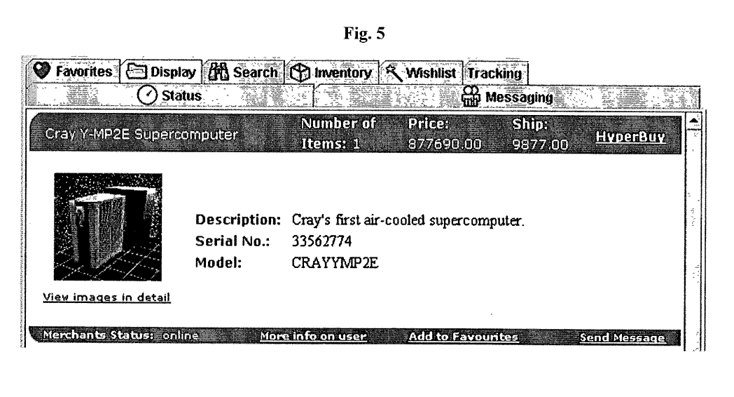

FIG. 5 depicts a sample display screen. The display screen gives the description of the selected product(s) including pictures. Users may also get more information about the seller or contact the seller, add the seller to the user's favorites and buy the product. A user desiring to buy a product would click on a designated button which leads to an input screen where the user is prompted to enter billing information. The system servers then process the transaction for authorization.

Favorites Screen.

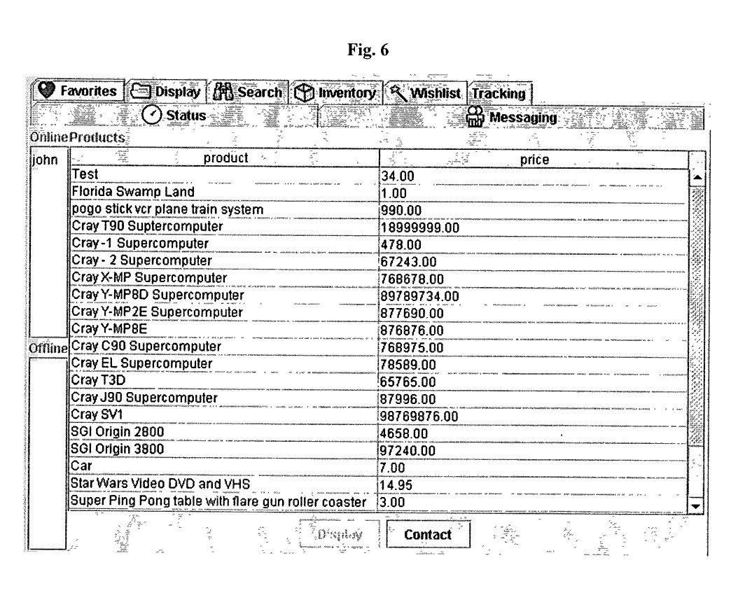

FIG. 6 depicts a sample favorites screen. The favorites screen allows the displaying of products from selected merchants. Users may “bookmark” buyers or sellers.

Chat/Messaging Screen.

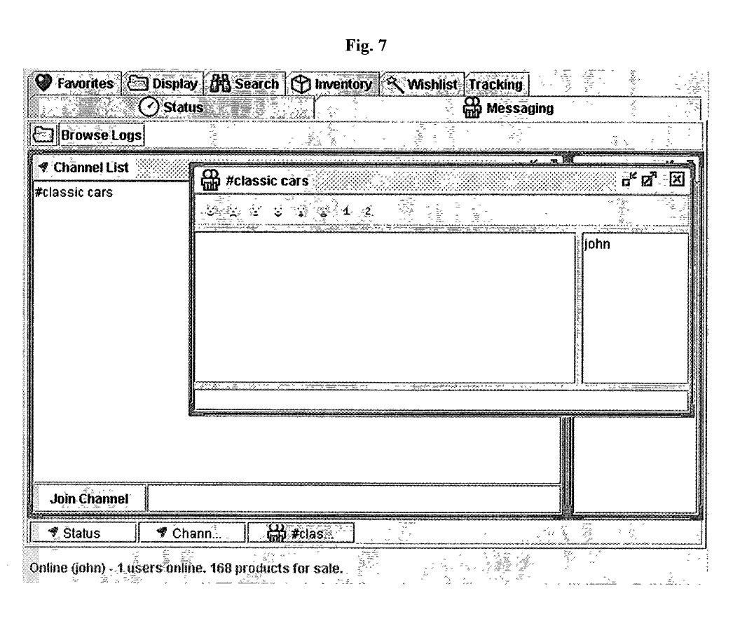

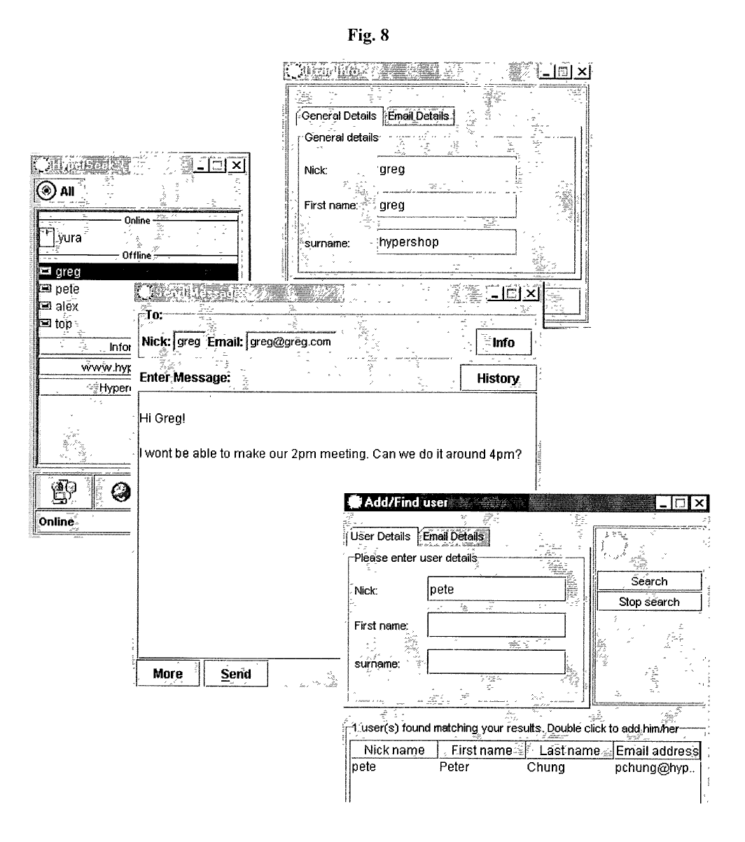

FIG. 7 depicts a sample messaging screen. The chat/messaging screen allows users to instant message buyers or sellers regarding or goods, services or interests. FIG. 8 depicts sample screens of the instant messaging user application.

Inventory Control Screen.

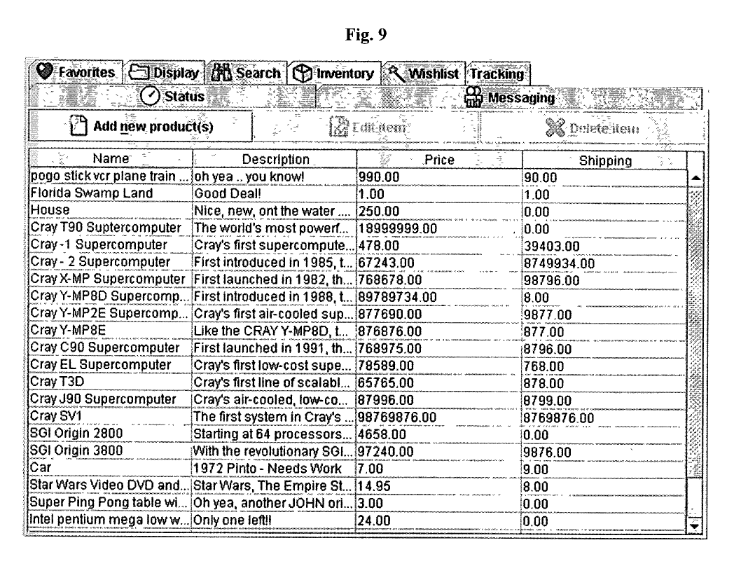

FIG. 9 depicts a sample inventory control screen. The inventory control screen gives sellers the ability to enter, delete or modify the items they have posted to sell. A user can also enter items they are searching to buy. Inventory may be sorted by name, price, description, shipping terms or other criteria. When an item is sold, it is automatically removed from the user's inventory and product quantity is updated. This is also where banner ads are created/maintained.

Order-Tracking Screen.

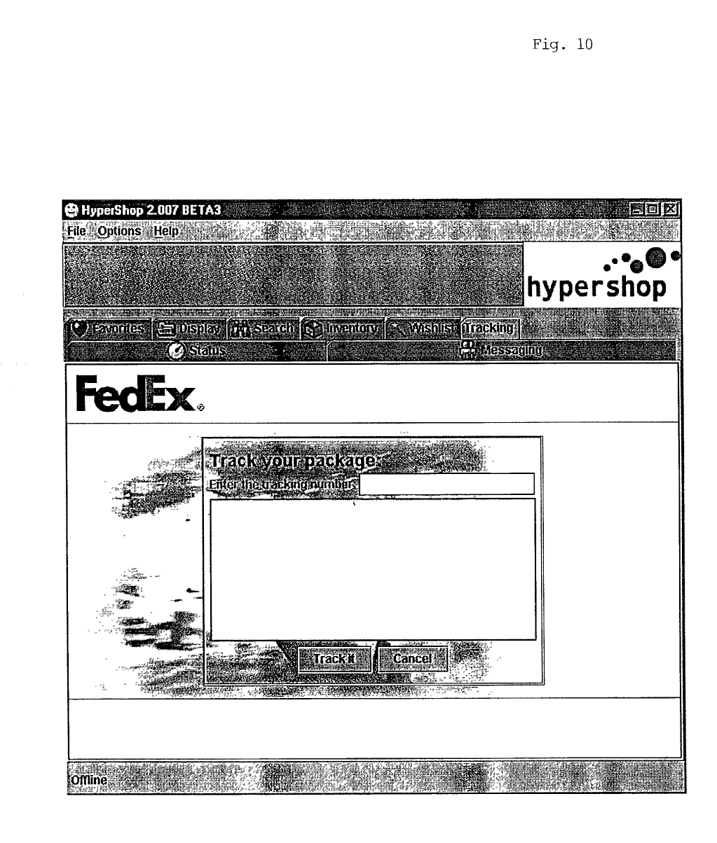

FIG. 10 depicts a sample order-tracking screen. The order-tracking screen allows a user to track their purchase through multiple carriers, which has been approved by major shippers.

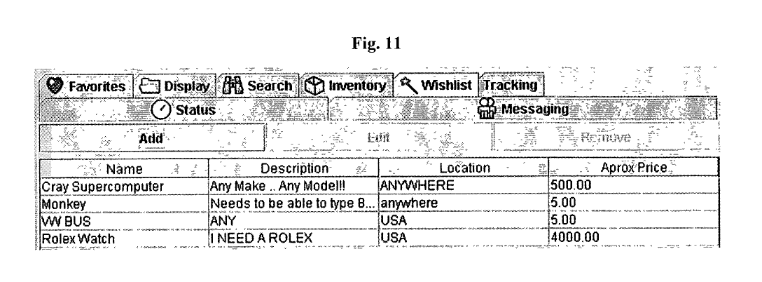

The graphical user interface could be designed differently while still providing equivalent functionality. This can be expanded to include shipping as well as tracking. A wish list or product/service request screen could also be included. A sample is depicted in FIG. 11.

The user-side software application is resident on the user's computer and provides a high-level, secure, user interface to the system network and its servers. There is a centralized user registration routine for signing up and authenticating new users. This also works on the backend with a local advertising server, in a preferred embodiment of the system, that is a component residing within the local broadband network providing advertising content to users.

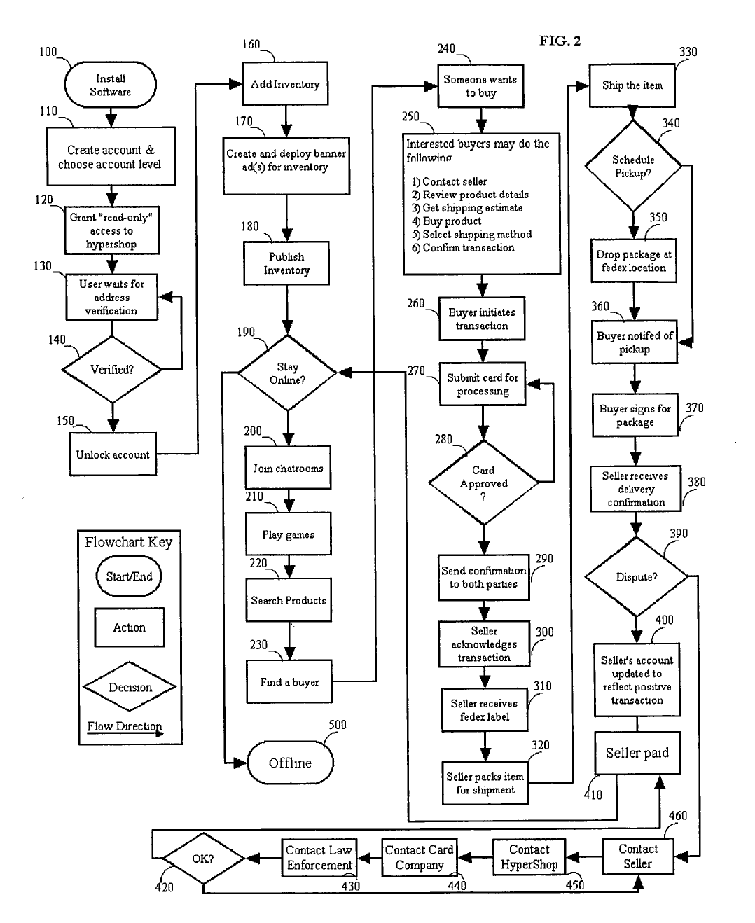

Referring to FIG. 2, which describes the overall process flow of the method of the present invention in a preferred embodiment, users of the system install the system software 100 on their CPU. Users connect to the system by clicking on the user-end software application icon, which opens and displays a logon window. If this is the user's first time using the system, the user will be required to fill in the registration fields in the registration before logging on to create a user account and select an account level 110. After registration is completed the user can log on. Read-only access is granted initially 120, and the user waits for address verification 130. If verified 140, the user's account is made available 150. In the future, when opening the application, the logon window appears and users need only give their user name, password, and click “connect.” After the initial account setup, the users may store logon information for automatic connection to the system with no user intervention. The user accounts preferably also have a lockout period. This period is used to verify the user's mailing address. The new user will get a letter from the system administration, via snail mail, with a code. This code will unlock the user's user-end software and verify the user's address with the system administrator. After this point, users may buy and sell on the system network. Sellers can add inventory 160, create and display banner ads for inventory 170, and publish inventory listings 180.

A potential purchaser of goods can search for particular items or categories of items 220. After the system develops a profile on the user, the system alerts a user that items are for sale for which the user has previously expressed an interest. As with a person operating a garage sale, where the seller remains on the property with the seller's goods until the goods are sold, the seller is encouraged, but not required, to remain online during the time which the seller's product is being offered.

The system permits a potential buyer of the seller's product to either click on a chat room link 200, which will enable the potential buyer and seller to negotiate the price of the goods/services, or to leave the seller a message with a return contact address or number 250. Once goods are sold the seller can easily remove the items from the system database. The system works much like a flea market in the sense that buyers and sellers arrange for their own method of payment. In a preferred embodiment using a credit or prepaid card for payment, initiates a transaction 260 and submits his or her card information for processing 270. If the card is approved 280, the system sends confirmation to both parties 290. The seller acknowledges the transaction 300, receives a shipping label 310, packs the purchased item for shipment 320 and ships the item 330. Delivery is accomplished through steps 340-360 and the seller receives delivery confirmation 380. If there is a dispute 390 the seller is contacted 460, as well as the system 450, the card issuer 440 and if needed, law enforcement is also contacted 430. Once the transaction is completed, the seller's account is updated to reflect the transaction 400 and the seller is paid 410.

Online processing and payment applications options, such as clicking to access one or more companies that can process credit card payments, can be incorporated in various embodiments of the system.

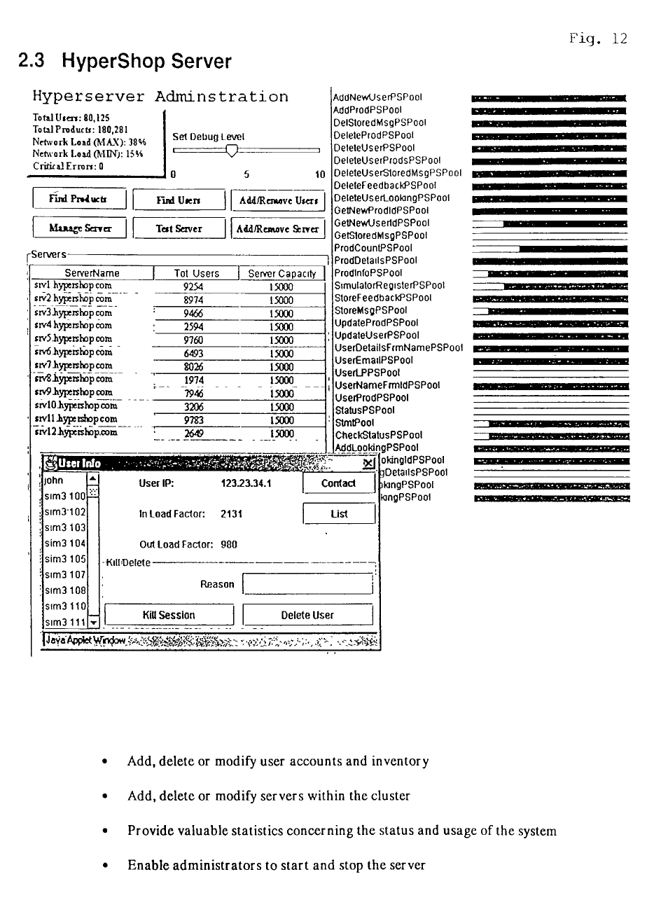

The system server software operates behind the scenes to coordinate the different functions of the user software. The system server software works on the backend of the system network and works as the gateway to the system database. This software is not accessible to users and is accessed by the network administrator through a GUI. The server operates to manage system functions, such as adding, deleting and modifying user accounts and inventory. The server provides valuable statistics concerning the status and usage of the system network while allowing system administrators to add, delete or modify servers within the cluster and if necessary start and stop the system server. A system administration representative screen of the system-end software application in a preferred embodiment is provided in FIG. 12. The system server software runs in the background and is the gateway to the database of products, which the user software can access. The server software is run and maintained on one or more dedicated system servers. There is also a user analysis system, which is a server-side tool kit for analyzing user choices to optimize the user's experience and interests.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. An Internet-based instant messaging hybrid peer-to-peer distributed electronic commerce system comprising:
a system-end main processing unit including one or more system-end software applications for administration of system functions;
a system-end communications server communicating with said system-end main processing unit for system communications with system users via the Internet;
a system-end mass storage device communicating with said system-end main processing unit including one or more searchable relational databases containing data pertaining to system users as well as goods or services offered for sale on the system by said system users;
a system-end transaction server communicating with said system-end main processing unit for processing system user e-commerce transactions;
a user-end computer communicating with the system and other system users via the Internet;
one or more user-end software applications providing a graphical user interface for system users to interact with the system and other system users; and
a user-end peer-to-peer instant messaging software application integrated with both said user-end software applications and said system-end software applications for direct peer-to-peer communications between system users.

2. The system of claim 1, wherein said one or more user-end software applications further comprise one or more software applications for user goods inventory tracking.

3. The system of claim 1, wherein said one or more user-end software applications further comprise one or more software applications for user e-commerce counterparty contact information management.

4. The system of claim 1, further comprising one or more user-end data encryption and decryption software applications for system users to send and receive secure communications to and from other system users.

5. The system of claim 1, further comprising one or more user-end electronic signature generation and authentication software applications.

6. The system of claim 1, further comprising on or more system-end electronic payment processing software applications.

7. The system of claim 1, wherein said user-side computer means utilizes wireless communications hardware and protocols.

8. The system of claim 1, further comprising one or more system-end software applications for system capacity monitoring.

9. The system of claim 1, wherein said one or more user-side software applications provide a graphical user interface for system users to interact with the system and other users, comprising a search screen, a goods/services display screen, a messaging screen, an inventory control screen and an order tracking screen.

10. A method for engaging in electronic commerce via the Internet, comprising the following steps:
installing one or more user-side software applications providing a graphical user interface for system users to interact with the system and other system users and peer-to-peer instant messaging functionality on a user computer system communicating via the Internet;
establishing a user account with a hybrid peer-to-peer distributed electronic commerce system comprising a mass storage device which includes one or more searchable relational databases containing user, goods/services and transaction data, an Internet communications server, a transaction server for processing system user e-commerce transactions and a main processing unit including one or more system-end software applications for administration of system functions;
searching said system databases for goods/services advertised on said system;
selecting goods/services for purchase;
contacting the seller of said goods/services via said user-end peer-to-peer instant messaging software application to negotiate the terms of purchase for said goods/services;
processing said purchase via said system's transaction server to transmit payment for said goods/services from the purchaser to the seller, update said system's goods/services inventory data and arrange for delivery of said purchased goods/services to the buyer.
